(19) United States
(12) Patent Application Publication
(10) Pub. No.: US 2018/0165715 A1
(43) Pub. Date: Jun. 14, 2018

(54) System and Method for Measuring Customer Behavior

(71) Applicant: Zaius, Inc., Leesburg, VA (US)

(72) Inventors: Spencer Eldon Pingry, Leesburg, VA (US); Matthew Tharp, Wayland, MA (US)

(21) Appl. No.: 15/833,233

(22) Filed: Dec. 6, 2017

Related U.S. Application Data
(60) Provisional application No. 62/431,448, filed on Dec. 8, 2016.

(51) Int. Cl. G06Q 30/02

(52) U.S. Cl. CPC G06Q 30/0269; G06Q 30/0267; G06Q 30/0204; G06Q 30/0201; G06Q 30/0277

(57) ABSTRACT

Various implementations of the invention for displaying customer behavior measurements to a user are described. In some implementation of the invention, customer behavior measurements are displayed by: categorizing each of a plurality of customers into one of a plurality of lifecycle stages based on one or more interactions of each of the plurality of customers with a seller, wherein each of the plurality of lifecycle stages corresponds to a different stage of relationship between customers and the seller, wherein each interaction is represented by a data record in a data storage; displaying a first value associated with each of the plurality of lifecycle stages, wherein the first value comprises a number of the plurality of customers categorized in its associated lifecycle stage or a percentage that the number of the plurality of customers categorized in its associated lifecycle stage represents across all lifecycle stages; categorizing each of the corresponding customers into one of a plurality of buying cycle stages based a type of interaction with the seller for each of the corresponding customers, wherein each of the plurality of buying cycle stages corresponds to a different stage of buying behavior for the customers; displaying a second value associated with each of the plurality of buying cycle stages, wherein the second value comprises a number of the corresponding customers categorized in its associated buying cycle stage or a percentage that the number of the plurality of customers categorized in its associated buying cycle stage represents across all buying cycle stages; for each of the plurality of lifecycle stages or for each of the plurality of buying cycles stages, categorizing each of the corresponding customers into one of a plurality of dimension groups based on a type of a dimension characterizing the interaction with the seller for each of the corresponding customers; and displaying a third value associated with each of the plurality of dimension groups, wherein the third value comprises a number of the corresponding customers categorized in its associated dimension group or a percentage that the number corresponding customers categorized in its associated dimension group represents across all dimension groups. In some implementations of the invention, the customers in a given lifecycle category, a given buying cycle category, a given dimension group, or combinations thereof, may be provided targeted advertising.

### CROSS-REFERENCE TO RELATED APPLICATIONS

This Application claims priority to U.S. Provisional Application No. 62/431,448, which was filed on Dec. 8, 2016, and entitled “System and Method for Measuring Customer Behavior.” The foregoing application is incorporated herein by reference in its entirety.

### FIELD OF THE INVENTION

The invention is generally related to data storage and more particularly, to acquiring, analyzing, and measuring a customer's interaction with a seller.

### BACKGROUND OF THE INVENTION

Various conventional data storage systems attempt to track and monitor a customer's interactions with a website in order to ascertain buying behavior of the customer. However, these conventional data storage systems typically fail to acquire sufficient data at a proper level of granularity to understand and analyze such customer interactions.

What are needed are improved systems and methods for storing and retrieving data, especially in an online, real-time data storage system. What are further needed are such systems that are designed to organize, analyze and present such data in a manner that permits influence of such customer behavior.

### SUMMARY OF THE INVENTION

Various implementations of the invention for displaying customer behavior measurements to a user are described. In some implementation of the invention, customer behavior measurements are displayed by: categorizing each of a plurality of customers into one of a plurality of lifecycle stages based on one or more interactions of each of the plurality of customers with a seller, wherein each of the plurality of lifecycle stages corresponds to a different stage of relationship between customers and the seller, wherein each interaction is represented by a data record in a data storage; displaying a first value associated with each of the plurality of lifecycle stages, wherein the first value comprises a number of the plurality of customers categorized in its associated lifecycle stage or a percentage that the number of the plurality of customers categorized in its associated lifecycle stage represents across all lifecycle stages; categorizing each of the corresponding customers into one of a plurality of buying cycle stages based a type of interaction with the seller for each of the corresponding customers, wherein each of the plurality of buying cycle stages corresponds to a different stage of buying behavior for the customers; displaying a second value associated with each of the plurality of buying cycle stages, wherein the second value comprises a number of the corresponding customers categorized in its associated buying cycle stage or a percentage that the number of the plurality of customers categorized in its associated buying cycle stage represents across all buying cycle stages; for each of the plurality of lifecycle stages or for each of the plurality of buying cycles stages, categorizing each of the corresponding customers into one of a plurality of dimension groups based on a type of a dimension characterizing the interaction with the seller for each of the corresponding customers; and displaying a third value associated with each of the plurality of dimension groups, wherein the third value comprises a number of the corresponding customers categorized in its associated dimension group or a percentage that the number corresponding customers categorized in its associated dimension group represents across all dimension groups. In some implementations of the invention, the customers in a given lifecycle category, a given buying cycle category, a given dimension group, or combinations thereof, may be provided targeted advertising. These and other implementations of the invention, and their respective features, are described in further detail below.

### BRIEF DESCRIPTION OF THE DRAWINGS

FIG. 1 illustrates a data storage system according to various implementations of the invention.

FIG. 2 illustrates an environment in which various implementations of the invention operate.

FIG. 3 illustrates an example graphic user interface according to various implementations of the invention.

FIGS. 4A and 4B illustrate portions of FIG. 3 in further detail.

FIG. 5 illustrates an operation of the invention according to various implementations of the invention.

### DETAILED DESCRIPTION

Various implementations of the invention may utilize and operate in connection with a data storage system provided by Zaius, Inc., of Leesburg, Va. and as described in: U.S. patent application Ser. No. 14/562,610, filed on Dec. 5, 2014 and entitled “System and Method for Storing and Retrieving Data in Different Data Spaces;” U.S. patent application Ser. No. 14/562,611, filed on Dec. 5, 2014 and entitled “System and Method for Creating Storage Containers in a Data Storage System;” and U.S. patent application Ser. No. 14/562,612, filed on Dec. 5, 2014 and entitled “System and Method for Load Balancing in a Data Storage System.” Each of the foregoing applications is incorporated herein by reference.

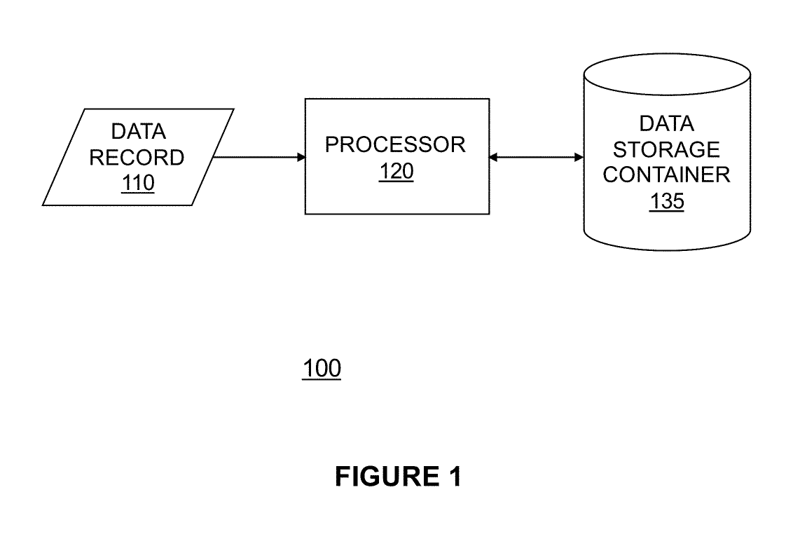

FIG. 1 illustrates a data storage system 100 according to various implementations of the invention. Data storage system 100 includes a processor 120 and at least one data storage container 135. According to various implementations of the invention, a data record 110 is stored in data storage container 135. Data storage container 135 corresponds to a logical data storage element which may be stored on one or more physical data storage assets (not otherwise illustrated in FIG. 1). According to various implementations of the invention, physical data storage assets may include, but are not limited to servers, disks, memories, other non-transitory computer readable media, or other physical data storage assets including banks or farms of such physical data storage assets.

According to various implementations of the invention, processor 120 may be any general purpose hardware computing processor configured via various executable programming instructions stored internally to or externally from processor 120 in a computer readable medium, where when such programming instructions are executed by the computing processor, they cause the computing processor to perform various functions as would be appreciated. When configured with such programming instructions, the general purpose hardware computing processor becomes a particular processor that performs functions attributed to processor 120 as described herein. According to various implementations of the invention, processor 120 may be a single hardware computing processor or a plurality of hardware computing processors. According to various implementations of the invention, processor 120 may be a dedicated hardware computing processor configured to perform various functions of processor 120 as described herein or a plurality of hardware computing processors distributed throughout data storage system 100, each configured to perform one or more of the functions of processor 100 as described herein.

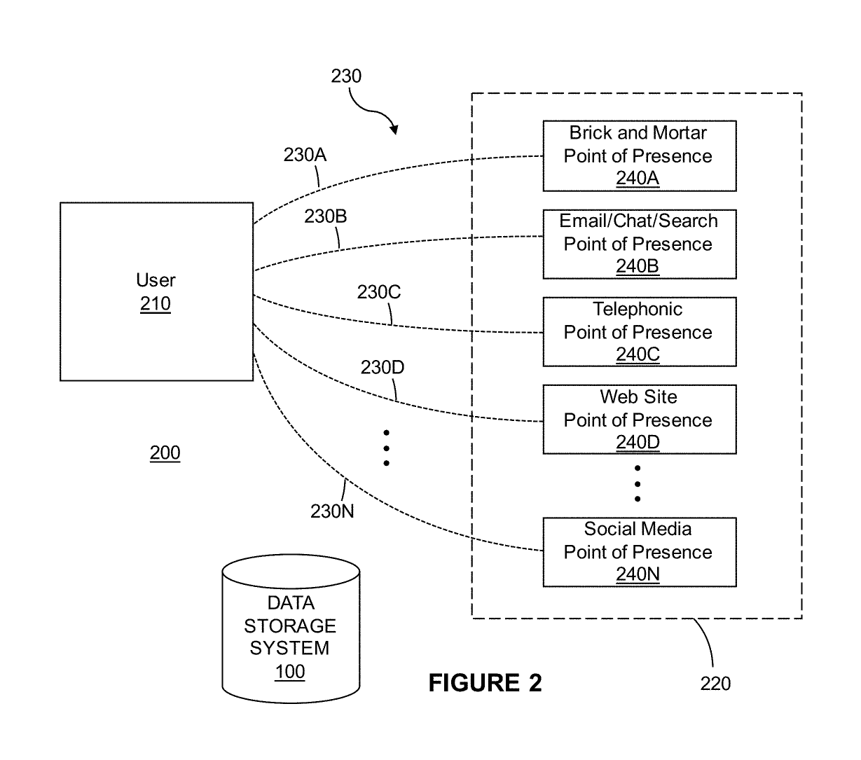

According to various implementations of the invention, data storage system 100 may be used in an environment 200 as illustrated in FIG. 2 to acquire and store various interactions 230 (illustrated as an interaction 230A, an interaction 230B, an interaction 230C, an interaction 230D, . . . , and an interaction 230N) between a customer 210 and a seller 220. As illustrated, seller 220 may have one or more point of presence 240 (illustrated as a point of presence 240A, a point of presence 240B, a point of presence 240C, a point of presence 240D, . . . , and a point of presence 240N) within environment 200. Points of presence 240 may correspond to physical points of presence, or to electronic points of presences. Points of presence 240 may sometimes also be referred to as channels. For example, as illustrated, customer 210 may interact in person with seller 220 via a bricks-and-mortal store point of presence 240A during interaction 230A or telephonically with seller 220 via a customer service representative point of presence 240C during interaction 230C; or customer 210 may interact electronically with seller 220 via a website point of presence 240D during interaction 230D or an email/chat/search point of presence 240B during interaction 230B; or customer 210 may interact directly or indirectly with seller 220 via social media point of presence 240N during interaction 230N. Customer 210 may interact with seller 220 in other manners and/or via other points of presence 240 during other interactions 230 as would be appreciated. According to various implementations of the invention, data storage system 100 acquires and stores each interaction 230 between customer 210 and seller 220; in some implementations of the invention, such interactions 230 are acquired and stored in real time.

According to various implementations of the invention, various pieces of information (e.g., data) regarding each interaction 230 between customer 210 and seller 220 may be gathered, generated, or otherwise acquired. Such information may include, but is not limited to, information describing customer 210, seller 220, point of presence 240, etc., and interaction 230, itself, including, but not limited to, date, time, products or services viewed/selected/purchased, origin, etc. As would be appreciated, any information that can be gleaned regarding customer 210, seller 220, point of presence 240 and interaction 230 may be stored as data records in a data store.

According to various implementations of the invention, customers 210 may be organized into categories (i.e., categorized) based on an entirety of their respective interactions 230 with seller 220. Such categories are referred to herein as “lifecycle stages” and describe a nature of a relationship between each of customers 210 and seller 220. According to various implementations of the invention, customers 210 may be organized into different lifecycle stages based on a number of products or services purchased during their respective entirety of interactions 230 with seller 220. Such lifecycle stages may include: a “no purchaser” lifecycle stage which includes customers 210 that have interacted with seller 220 but have not ever purchased a product or service from seller 220; a “single purchaser” lifecycle stage which includes customers 210 that have interacted with seller 220 and have exactly one purchase transaction (a purchase transaction may include multiple products or services purchased during such transaction) with seller 220; a “repeat purchaser” lifecycle stage which includes customers 210 that have interacted with seller 220 and have exactly two purchase transactions with seller 220; and a “loyal purchaser” lifecycle stage which includes customers 210 that have interacted with seller 220 and have three or more purchase transactions with seller 220. Fewer, more or other lifecycle stages and/or other definitions of such lifecycle stages may be used as would be appreciated.

According to various implementations of the invention, customers 210 may be organized into different lifecycle stages based on revenue generated from their respective entirety of interactions 230 with seller 220. Such lifecycle stages may include: a “$0 revenue” lifecycle stage which includes customers 210 that have interacted with seller 220 but have not purchased any products or services from seller 220; a “$0-$50” lifecycle stage which includes customers 210 that have interacted with seller 220 and have purchased $0-$50 worth of products or services from seller 220; a “$50-$200” lifecycle stage which includes customers 210 that have interacted with seller 220 and have purchased $50-$200 worth of products or services from seller 220; and a “$200+” lifecycle stage which includes customers 210 that have interacted with seller 220 and have purchased $200 or more worth of products or services from seller 220. More generally, such lifecycle stages may include: a “$0 revenue” lifecycle stage which includes customers 210 that have interacted with seller 220 but have not purchased any products or services from seller 220; a “$0-$X₁” lifecycle stage which includes customers 210 that have interacted with seller 220 and have purchased $0-$X₁ worth of products or services from seller 220; a “$X₁-$X₂” lifecycle stage which includes customers 210 that have interacted with seller 220 and have purchased $X₁-$X₂ worth of products or services from seller 220; and a “$X₂+” lifecycle stage which includes customers 210 that have interacted with seller 220 and have purchased $X₂ or more worth of products or services from seller 220 (where X₂>X₁>0. Fewer, more or other revenue-based lifecycle stages and/or other definitions of such revenue-based lifecycle stages may be used as would be appreciated.

According to various implementations of the invention, customers 210 may be organized into lifecycle stages based on level or frequency/period of engagement with seller 220. Such lifecycle stages may include: an “customer engages quarterly” lifecycle stage which includes customers 210 that have interacted with seller 220 within a quarterly period; an “customer engages monthly” lifecycle stage which includes customers 210 that have interacted with seller 220 within a monthly period; an “customer engages weekly” lifecycle stage which includes customers 210 that have interacted with seller 220 within a weekly period; and an “customer engages daily” lifecycle stage which includes customers 210 that have interacted with seller 220 within a daily period. More generally, such lifecycle stages may include: an “customer engages within a first period” lifecycle stage which includes customers 210 that have interacted with seller 220 within the first period; an “customer engages within a second period” lifecycle stage which includes customers 210 that have interacted with seller 220 within the second period; etc. (where the first period is greater than the second period, etc.). Fewer, more or other engagement-based lifecycle stages and/or other definitions of such engagement-based lifecycle stages may be used as would be appreciated.

According to various implementations of the invention, customers 210 may be organized into lifecycle stages based on a purchase frequency from seller 220. Such lifecycle stages may include: a “purchases annually” lifecycle stage which includes customers 210 that have interacted with seller 220 and purchased products or services within an annual period; a “purchases quarterly” lifecycle stage which includes customers 210 that have interacted with seller 220 and purchased products or services within a quarterly period; a “purchases monthly” lifecycle stage which includes customers 210 that have interacted with seller 220 and purchased products or services within a monthly period; a “purchases weekly” lifecycle stage which includes customers 210 that have interacted with seller 220 and purchased products or services within a weekly period. Fewer, more or other engagement-based lifecycle stages and/or definitions of such purchase-based lifecycle stages may be used as would be appreciated.

According to various implementations of the invention, customers 210 may be organized (or further organized) into categories based on a nature of their interactions 230 with seller 220, referred to herein as “buying cycle stages.” These buying cycle stages may include: an “at risk” buying cycle stage which includes customers 210 that have not interacted with seller 220 across any channel for more than 30 days; a “recent buyer” buying cycle stage which includes customers 210 that purchased a product or service within 30 days but have not since interacted with seller 220; an “awareness” buying cycle stage which includes customers 210 that interacted with seller 220 within 30 days; an “interest” buying cycle stage which includes customers 210 that have shown a basic level of interest in a product or service by, for example, interacting with such product or service by viewing a product page, etc.; a “considering” buying cycle stage which includes customers 210 that have shown a further interest in a product or service by, for example, interacting with such product or service by viewing a same product page twice, etc.; and an “intent” buying cycle stage which includes customers 210 that have shown real purchase intent by, for example, placing a product or service in a shopping cart, etc. Fewer, more or other buying cycle stages and/or definitions or periods of such buying cycle stages may be used as would be appreciated.

In some implementations of the invention, customers 210 categorized into each lifecycle stage may be further categorized into one of the buying cycle stages. In some implementations of the invention, customers 210 categorized into each buying cycle stage may be further categorized into one of the lifecycle stages. In some implementations of the invention, the plurality of lifecycle stages are mutually exclusive from one another; that is a given customer does not simultaneously exist in two different lifecycle stages with a given seller. In some implementations of the invention, the plurality of buying cycle stages are mutually exclusive from one another; that is, a given customer does not simultaneously exist in two different buying cycle stages with a given seller.

According to various implementations of the invention, each of the lifecycle stages and/or buying cycle stages may be further categorized into various dimensions based on the various information gathered, generated, and/or acquired regarding interaction 230. Such dimensions may include, but are not limited to: an average order value (“AOV”) dimension; a cost per click ad type dimension; a region (e.g., state, etc.) dimension; a country dimension; a postal code dimension; a mobile device dimension; a page duration dimension; a session duration dimension; an operating system dimension; a browser dimension; a page title dimension; an advertising referral source dimension; a keyword search term referral dimension; an original advertising source of a customer session dimension; an advertising source related to specific customer session dimension; a language dimension; a days since last visit dimension; a landing page dimension; an advertising campaign dimension; a device type dimension; an on-site or in-app search term dimension; a product ID dimension; a product brand dimension; an hour dimension; a day dimension; a week dimension; a hour of day dimension; a day of week dimension; a quantity of products purchased dimension; a navigation used dimension; a product name dimension; an order timestamp dimension; an order ID dimension; an order number dimension; an order discount dimension; an order coupon code dimension; a purchase count dimension; a customer browsed dimension; a customer viewed dimension; a customer added to cart dimension; a customer removed from cart dimension; a customer purchased dimension; a root category dimension; a product detail view dimension; and/or other dimension related to customer 210, to their interaction(s) 230 with seller 220, to seller 220, and/or products or services offered by seller 220.

According to various implementations of the invention, a value of a given dimension in a corresponding lifecycle stage and/or buying cycle stage is calculated based on the value of that dimension within that given stage. For example, if a customer 210 has a mobile device interaction 230 with seller 220 as a “no purchaser” and then subsequently has a desktop interaction 230 with seller 220 in its current stage as a “single purchaser,” then only the desktop interaction 230 is counted in the current stage. Further, any purchase dimensions (i.e., dimensions describing or relating to a product or service purchased) are calculated based on the particular purchase that moved customer 210 into its current stage. Still further, showing a “root category purchased” will present root categories of the products or services originally purchased by customer 210.

According to various implementations of the invention, lifecycle stages, buying cycle stages, and dimensions are individually configurable and individually selectable. Any such selections made may then be applied as filters to data records 110 in data storage system 100. In some implementations of the invention, identifying information (e.g., customer ID, phone number, email address, user name, customer loyalty program number, or other contact and/or identifying information, etc.) may be presented for each customer 210 that complies with such selections (referred to herein as a “filter segment”). In some implementations of the invention, the user may then select a given customer 210 in the filter segment to visualize data records 110 that justifies including the given customer 210 in the filter segment. In some implementations of the invention, the user may select a given filter segment in its entirety, and export it for use with a targeted marketing campaign. In some implementations of the invention, each of the customers 210 in the exported filter segment may be provided with target advertising. In some implementations, because the underlying data is collected and made available for analysis in real-time, the filter segment corresponds to an “up-to-the-minute” snapshot of customers 210 that match the various selected criteria.

According to various implementations of the invention, once customers 210 are categorized into either lifecycle stages and/or buying cycle stages, various metrics for each particular stage may be determined and presented to a user. Such metrics may include: a “number of customers” metric that measures a number of customers 210 in that particular stage; a “percentage of customers” metric that measures the number of customers 210 in that particular stage as a percentage of a total number of customers across all stages; a “total revenue” metric that measures a total amount of revenue of products or services purchased from seller 220 by customers 210 in that particular stage; a “percentage convert” metric that measures the total number of customers 210 in more valuable stages divided by the sum of the number of customers in the particular stage and the total number of customers 210 in the more valuable stages (e.g., for a single purchase cycle stage the percentage convert metric is determined by (number of customers 210 in the repeat purchaser lifecycle stage plus the number of customers 210 in the loyal lifecycle stage) divided by (number of customers 210 in the single purchaser lifecycle stage plus number of customers 210 in the repeat purchaser lifecycle stage plus the number of customers 210 in the loyal lifecycle stage)); a “days to covert” metric that measures a number of days a customer (or average number of days for a group of customers) was in a particular stage before advancing to a next more valuable stage; an “AOV” or “average order value” metric that measures a total value of all purchases of a product or service by customers 210 in that particular stage divided by the number of customers 210 in that particular stage. As would be appreciated, a user may configure which of the metrics to determine and/or display.

Similarly, according to various implementations of the invention, once customers 210 are categorized into either lifecycle stages and/or buying cycle stages, various metrics for each of one or more dimensions may be determined and presented to a user as will become apparent from the example below.

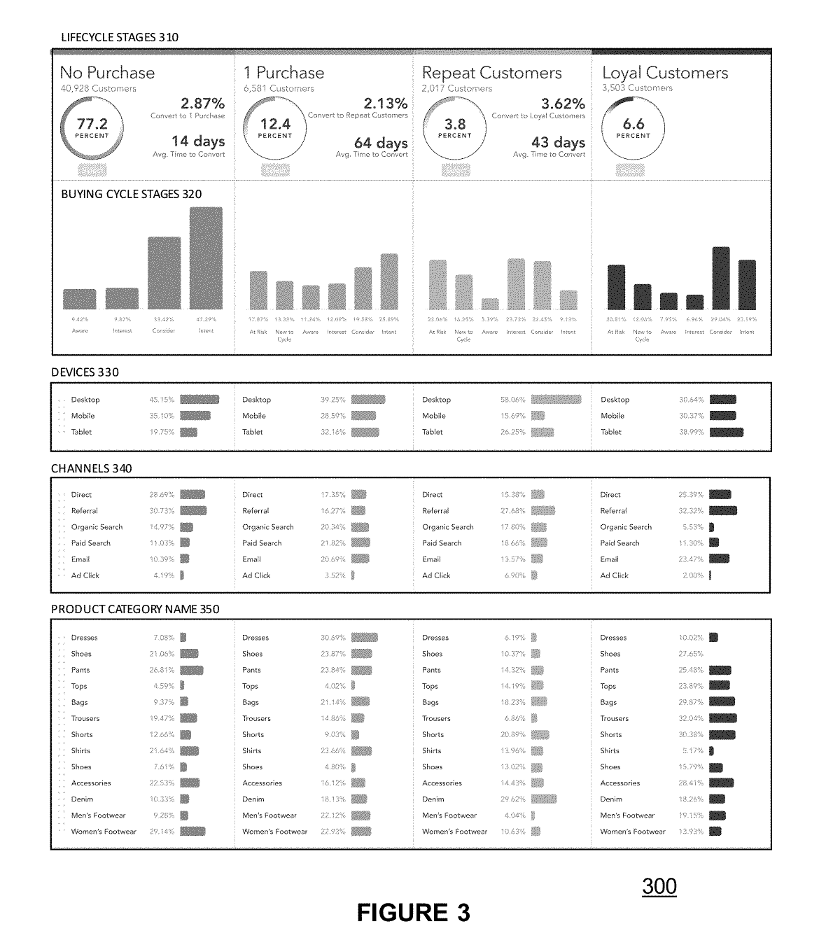

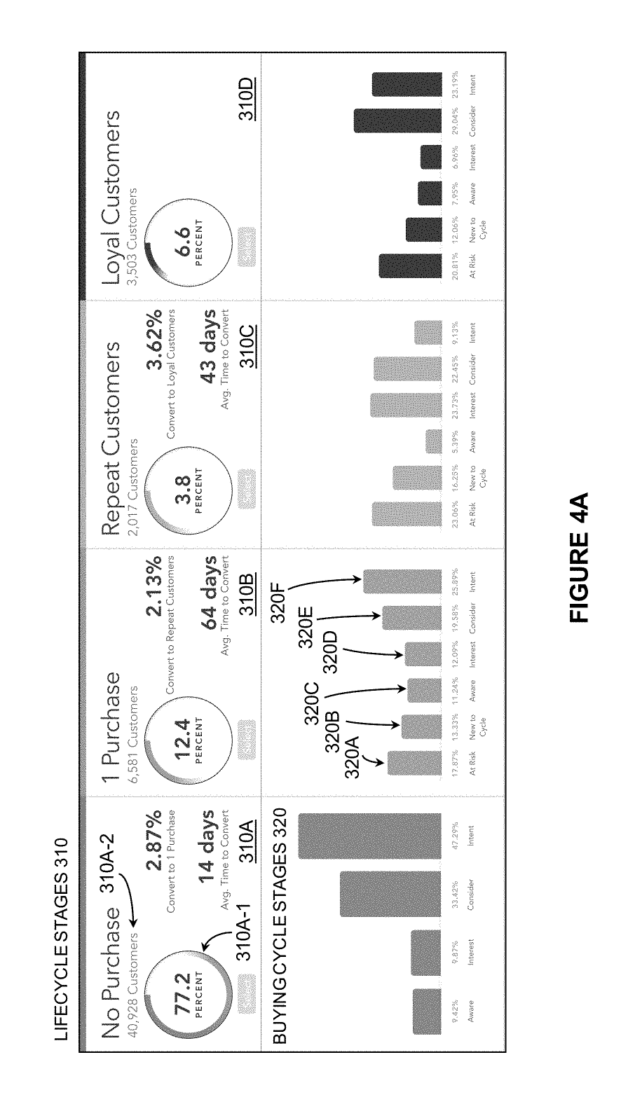

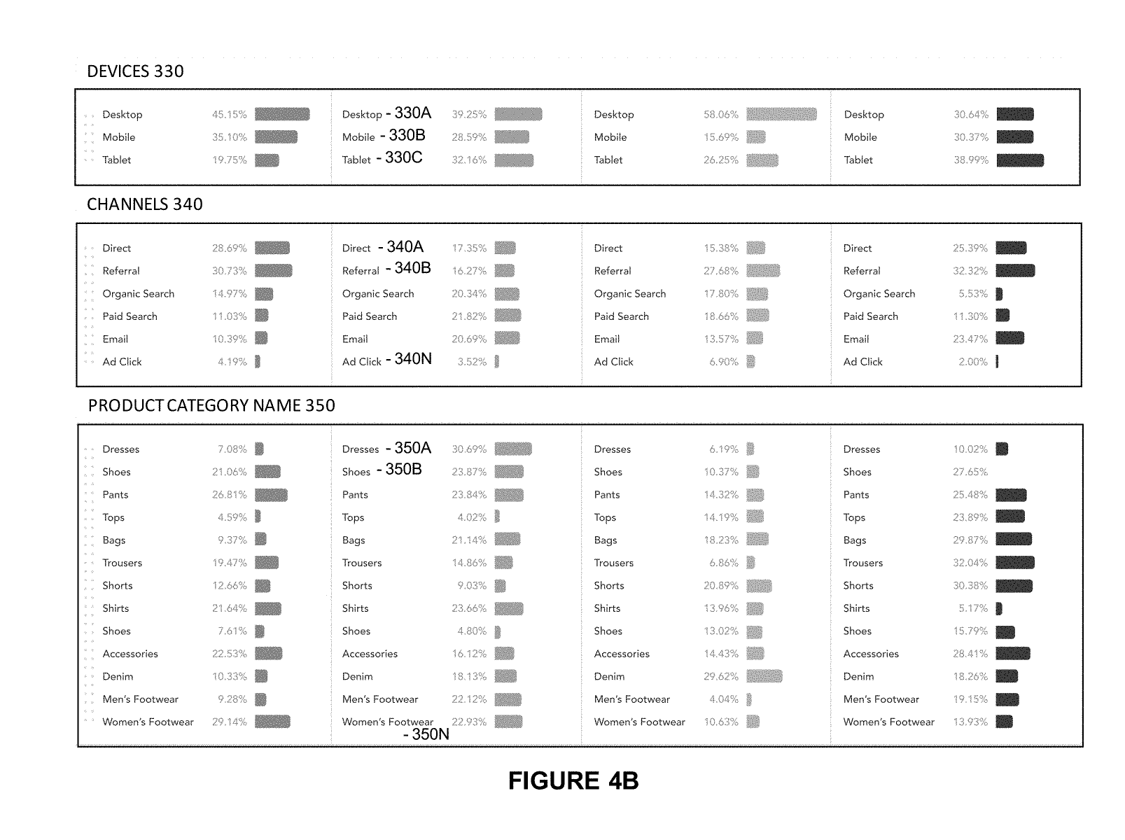

FIG. 3 illustrates an exemplary graphical user interface 300 that may be used in various implementations of the invention to display various customer behavior metrics to a user. FIGS. 4A and 4B illustrate aspects of FIG. 3 in further detail. These Figures are now described. Interface 300 includes a plurality of lifecycle stages 310 (illustrated in FIG. 4A as: a “no purchase” lifecycle stage 310A, a “1 purchase” lifecycle stage 310B, a “repeat customer” lifecycle stage 310C, and a “loyal customer” lifecycle stage 310D); a plurality of buying cycle stages 320 (illustrated in FIG. 4A as: an “at risk” buying cycle 320A, a “new to cycle” buying cycle 320B, an “aware” buying cycle 320C, an “interest” buying cycle 320D, an “consider” buying cycle 320E, and an “intent” buying cycle 320F); and a plurality of dimension groups (illustrated in FIG. 3 as: a “device” dimension group 330; a “channels” dimension group 340, and a “product category” dimension 350).

As illustrated in FIG. 3, customers 210 are categorized first in one of the plurality of lifecycle stages 310 based on their respective interactions 230. Then, the customers 210 in each of lifecycle stages 310 are then further categorized into one of the plurality of buying cycle stages 320, also based on their respective interactions 230. According to various implementations of the invention, all customers 210 are categorized into a single lifecycle stage 310 and further categorized into a single buying cycle stage 320. In some implementations of the invention (not otherwise illustrated), customers 210 may be categorized first in one of the plurality of buying cycle stages 320 based on their respective interactions 230; then, the customers 210 in each of buying cycle stage 320 are then further categorized into one of the plurality of lifecycle stages 310.

In some implementations of the invention, various metrics regarding customer 210 may be provided in interface 300. As illustrated in FIGS. 3 and 4A, a number of customers in each lifecycle stage 310 may be displayed (e.g., a number of customers 310A-2 in “no purchase” stage 310A) along with a percentage that such customers represent across those from all lifecycle stages 310 (e.g., a percentage of customers 310A-1 in “no purchase” stage 310A). For this example, 40,928 customers are in “no purchase” lifecycle stage 310A which represents 77.2% of all customers 210 interacting with seller 220; 6,581 customers are in “one purchase” lifecycle stage 310B which represents 12.4% of all customers 210 interacting with seller 220; 2,017 customers are in “repeat customer” lifecycle stage 310C which represents 3.8% of all customers 210 interacting with seller 220; and 3,503 customers are in “loyal customer” lifecycle stage 310D which represents 6.6% of all customers 210 interacting with seller 220. Various graphic elements may be used to depict such numbers and/or such percentages as would be appreciated.

As further illustrated in FIGS. 3 and 4A, for each lifecycle stage 310, a number of customers in each buying stage 320 may be quantified and displayed. For example, for “one purchase” lifecycle stage 310B, customers 210 are categorized into buying cycles 320. As illustrated, 17.87% of customers in “one purchase” lifecycle stage 310B are categorized in “at risk” buying cycle stage 320A; 13.33% of customers in “one purchase” lifecycle stage 310B are categorized in “new to cycle” buying cycle stage 320B; 11.24% of customers in “one purchase” lifecycle stage 310B are categorized in “aware” buying cycle stage 320C; 12.09% of customers in “one purchase” lifecycle stage 310B are categorized in “interest” buying cycle stage 320D; 19.58% of customers in “one purchase” lifecycle stage 310B are categorized in “consider” buying cycle stage 320E; and 25.89% of customers in “one purchase” lifecycle stage 310B are categorized in “intent” buying cycle stage 320F. Various graphic elements (as illustrated, a bar graph or histogram) may be used to depict such numbers and/or such percentages as would be appreciated.

As also illustrated in FIGS. 3 and 4A-B, once customers 210 are categorized first in one of the plurality of lifecycle stages 310, customers 210 in each of the plurality of lifecycle stages 310 may be further categorized into one or more dimension groups. For example, as illustrated in FIGS. 3 and 4A-B, customers 210 in “one purchase” lifecycle stage 310B are further categorized into a device dimension group 330 (illustrated as a “desktop” device group 330A, a “mobile” device group 330B, and a “tablet” device group 330C). Device dimension group 330 reflects a device type by which customer 210 interacted with seller 230. In this example, 39.25% of customers 210 in lifecycle stage 310B used a desktop device to interact with seller 230; 28.59% of customers 210 in lifecycle stage 310B used a mobile device to interact with seller 230; and 32.16% of customers 210 in lifecycle stage 310B used a tablet device to interact with seller 230.

As also illustrated in FIGS. 3 and 4A-B, customers 210 in “one purchase” lifecycle stage 310B are also further categorized into a channel dimension group 340 (illustrated as a “direct” channel group 340A, a “referral” channel group 340B, an “organic search” channel group, a “paid search” channel group, an “email” channel group, . . . , and an “ad click” channel group 340N). Channel dimension group 340 reflects a channel (or point of presence 230) through which customer 210 interacted with seller. In this example, 17.35% of customers 210 in lifecycle stage 310B used a direct channel to interact with seller 230; 16.27% of customers 210 in lifecycle stage 310B used a referral channel to interact with seller 230; 20.34% of customers 210 in lifecycle stage 310B used an organic search channel to interact with seller 230; 21.82% of customers 210 in lifecycle stage 310B used a paid search channel to interact with seller 230; 20.69% of customers 210 in lifecycle stage 310B used an email channel to interact with seller 230; and 3.52% of customers 210 in lifecycle stage 310B used an ad-click channel to interact with seller 230.

As also illustrated in FIGS. 3 and 4A-B, customers 210 in “one purchase” lifecycle stage 310B are also further categorized into a product category dimension group 350 (illustrated as a “dresses” product category group 350A, a “shoes” product category group 350B, a “pants” product category group, a “tops” product category group, a “bags” product category group, a “trousers” product category group, a “shorts” product category group, a “shirts” product category group, a “shoes” product category group, an “accessories” product category group, a “denim” product category group, a “men's footwear” product category group, . . . , and a “women's footwear” product category group 350N). FIG. 4B illustrates the breakdown of customers 210 that interacted with various product categories of seller 220. As would be appreciated, each customer 210 may interact with multiple products during a particular interaction 230, which is why the sum of the percentages does not equal 100.

For each of dimension groups 330, 340, 350, various graphic elements (as illustrated, a bar graph or histogram) may be used to depict values (e.g., numbers, percentages, etc.) as would be appreciated.

According to various implementations of the invention, the user may select numbers, percentages, or graphic elements in each lifecycle stage 310 or buying cycle stage 320 or dimensions 330, 340, 350 to display information regarding one or more customers 210. In some implementations, this information may include, but is not limited to, identifying information for such customers 210.

In some implementations of the invention, the user may export such identifying information as a contact list for a targeted advertising campaign. In some implementations of the invention, the user may use such identifying information to provide targeted advertising to such customers 210. In some implementations, the targeted advertising may include sending email marketing to such customers 210, pushing mobile notifications to such customers 210, providing in-app (e.g., social media, etc.) messages to such customers 210, delivering targeted web site messages to such customers 210, or other target advertising. For example, the user may cause an email or mobile message associated with the targeted advertising to be sent to one or each of the customers 210 in a given lifecycle and/or buying cycle stage or dimension as would be appreciated; in some implementations, such emails or messages may be tailored based on customers 210 stage(s) or dimension(s) as would be appreciated. As another example, different customers may be provided with different advertisements that get displayed on ad-network or social network based on customers 210 stage(s) or dimension(s). Other mechanisms and bases for targeted advertising may be used as would be appreciated.

In some implementations of the invention, the user may select an individual customer 210 to display any and all information regarding interactions 230 between customer 210 and seller 220. Such information may include, but is not limited to, dates, times, and durations of such interactions, lifecycle stage, buying cycle stage, date of purchases, date of first interaction, date of last interaction, product categories viewed, device types used, channels used, and/or any other dimension associated with customer 210 and its interactions 230 with seller 220.

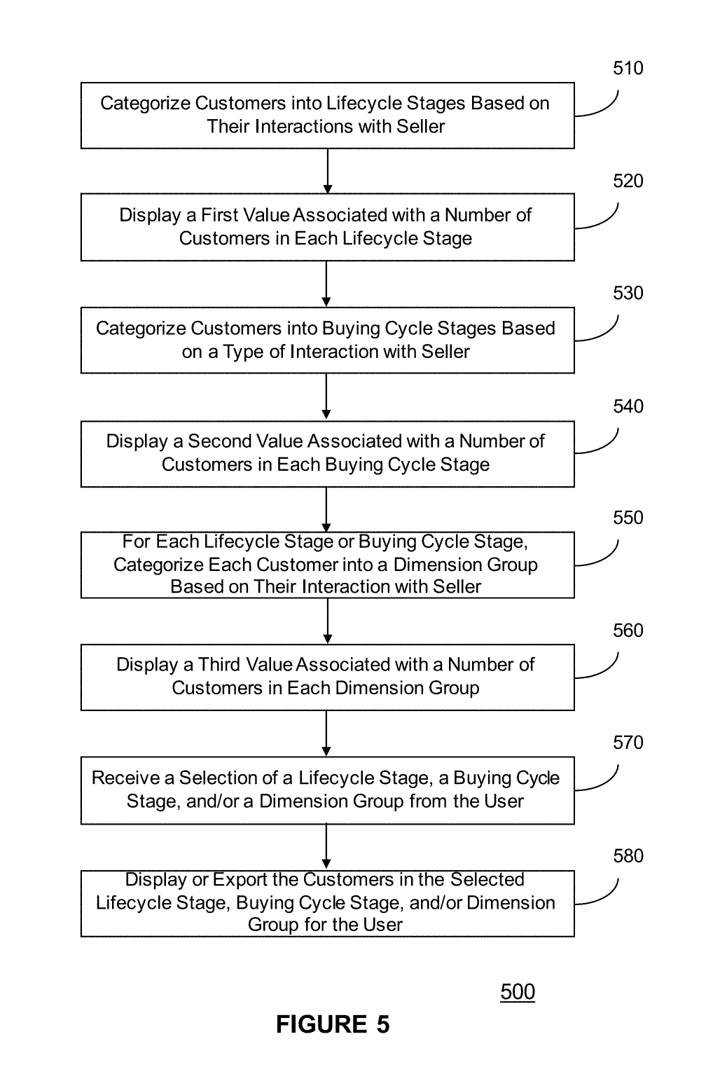

FIG. 5 illustrates an operation 500 of various implementations of the invention. In an operation 510, a plurality of customers 210 are categorized into one of a plurality of lifecycle stages 310 based on one or more interactions of each of the plurality of customers with a seller. In an operation 520, a first value associated with each of the plurality of lifecycle stages 310 is displayed to the user, where the first value comprises a number of customers 210 in that lifecycle stage 310 or a percentage of the number of customers 210 in that lifecycle stage 310 in relation to a total number of customers 210 across all lifecycle stages 310.

In an operation 530, for each of the plurality of lifecycles stages 310, the customers 210 in that lifecycle stage 310 are further categorized into one of a plurality of buying cycle stages 320 based a type of interaction 230 by those customers 210 with seller 220. In an operation 540, a second value associated with each of the plurality of buying cycle stages 320 is displayed to the user, where the second value comprises a number of customers 210 categorized in that buying cycle stage 320 within the given lifecycle stage 320 or a percentage of the number of customers 210 in that buying cycle stage 320 in relation to a total number of customers 210 within the given lifecycle stage 310.

In an operation 550, for each of the plurality of lifecycle stages 310 (or in some implementations for each of the plurality of buying cycles stages 320), each of the customers in that given lifecycle stage are categorized into one of a plurality of dimension groups based on a type of a dimension characterizing interaction 230 of customer 210 with seller 220. In an operation 560, a third value associated with each of the plurality of dimension groups is displayed to the user, where the third value comprises a number of customers 210 in that dimension group or a percentage of the number of customers 210 in that dimension group in relation to a total number of the customers within all of the dimension groups.

In some implementations of the invention, in operation 570, a selection of one of the plurality of lifecycle stages, one of the plurality of buying cycle stages, and/or one of the plurality of dimension groups is received from the user. In some implementations of the invention, in an operation 580, one or more customers that correspond to the selected lifecycle stage, buying cycle stage, and/or dimension group are displayed or exported to the user. In some implementations of the invention, targeted advertising may be sent, or caused to be sent, to the displayed or exported customers.

While the invention has been described herein in terms of various implementations, it is not so limited and is limited only by the scope of the following claims, as would be apparent to one skilled in the art. These and other implementations of the invention will become apparent upon consideration of the disclosure provided above and the accompanying figures. In addition, various components and features described with respect to one implementation of the invention may be used in other implementations as would be understood.

What is claimed is:

1. A method for displaying customer behavior measurements to a user, the method comprising:
categorizing each of a plurality of customers into one of a plurality of lifecycle stages based on one or more interactions of each of the plurality of customers with a seller, wherein each of the plurality of lifecycle stages corresponds to a different stage of relationship between customers and the seller, wherein each interaction is represented by a data record in a data storage;
displaying a first value associated with each of the plurality of lifecycle stages, wherein the first value comprises a number of the plurality of customers categorized in its associated lifecycle stage or a percentage of a total number of the plurality of customers in its associated lifecycle stage;
for each of the plurality of lifecycles stages, categorizing each of the corresponding customers into one of a plurality of buying cycle stages based a type of interaction with the seller for each of the corresponding customers, wherein each of the plurality of buying cycle stages corresponds to a different stage of buying behavior for the customers;
displaying a second value associated with each of the plurality of buying cycle stages, wherein the second value comprises a number of the corresponding customers categorized in its associated buying cycle stage or a percentage of a total number of the corresponding customers in its associated buying cycle stage;
for each of the plurality of lifecycle stages or for each of the plurality of buying cycles stages, categorizing each of the corresponding customers into one of a plurality of dimension groups based on a type of a dimension characterizing the interaction with the seller for each of the corresponding customers; and
displaying a third value associated with each of the plurality of groups, wherein the third value comprises a number of the corresponding customers categorized in its associated group or a percentage of a total number of the corresponding customers in its associated group.

2. The method of claim 1, wherein the plurality of lifecycle stages comprise: a no purchase stage, and an at least one purchase stage.

3. The method of claim 1, wherein the plurality of lifecycle stages comprise: a no purchase stage, a one purchase stage, and a more than one purchase stage.

4. The method of claim 1, wherein the plurality of lifecycle stages comprise: a no revenue stage, a $0-$X revenue stage and a greater than $X revenue stage, wherein such stages correspond to a total amount of revenue generated by the customer from the seller over a given period.

5. The method of claim 1, wherein the plurality of lifecycle stages comprise: a no revenue stage, a $0 to $X₁ revenue stage, and an $X₁ to $X₂ revenue stage, wherein such stages correspond to a total amount of revenue generated by the customer from the seller over a given period, and wherein X₂ is greater than X₁, which is greater than 0.

6. The method of claim 1, wherein the plurality of lifecycle stages comprise: a customer-engages-during-a-first-period stage, and a customer-engages-during-a-second-period stage, wherein such stages correspond to a frequency within which the customer engages with the seller at any point of presence of the seller, wherein the first period is longer than the second period.

7. The method of claim 1, wherein the plurality of lifecycle stages comprise: a customer-engages-quarterly stage, a customer-engages-monthly stage, a customer-engages-weekly stage, and a customer-engages-daily stage, wherein such stages correspond to a frequency within which the customer engages with the seller at any point of presence of the seller.

8. The method of claim 1, wherein the plurality of lifecycle stages comprise: a customer-purchases-within-a-first-period stage, and a customer-purchases-within-a-second-period stage, wherein such stages correspond to a frequency within which the customer purchases goods or services from the seller at any point of presence of the seller, wherein the first period is longer than the second period.

9. The method of claim 1, wherein the plurality of lifecycle stages comprise: a customer-purchases-annually stage, a customer-purchases-quarterly stage, a customer-purchases-monthly stage, and a customer-purchases-weekly stage, wherein such stages correspond to a frequency within which the customer purchases goods or services from the seller at any point of presence of the seller, wherein the first period is longer than the second period.

10. The method of claim 1, wherein one of the plurality of buying cycle stages comprises: an aware stage corresponding to the customer interacting with the seller at a point of presence, an interest stage corresponding to the customer viewing a product or a service of the seller at a point of presence, a consider stage corresponding to the customer viewing a same product or service of the seller two times at a point of presence, or an intent stage corresponding to the customer adding a product or service of the seller to a shopping cart.

11. The method of claim 1, wherein one of the plurality of buying cycle stages comprises: an at-risk stage corresponding to the customer not appearing at any point of presence within a given period or a recent buyer stage corresponding to the customer purchasing a product or service of the seller within the given period.

12. The method of claim 1, wherein the dimension comprises a device with which the customer interacts with the seller and wherein a type of the device comprises: a desktop device, a mobile device, a tablet device, or other device.

13. The method of claim 1, wherein the dimension comprises a channel from which the customer interacts with the seller and wherein a type of the channel comprises: a direct channel, a referral channel, an organic search channel, a paid search channel, an email channel, an ad-click channel, or other channel.

14. The method of claim 1, further comprising:
receiving a selection made by the user of one of the plurality of lifecycle stages, one of the plurality of buying cycle stages, and/or one of the plurality of dimension groups; and
displaying or exporting one or more customers to the user that correspond to the selected lifecycle stage, buying cycle stage, and/or dimension group.

15. The method of claim 14, further comprising:
providing targeted advertising to the displayed or exported customers.

16. The method of claim 15, wherein providing targeted advertising to the displayed or exported customers comprises sending email marketing to the customers, pushing mobile notifications to the customers, providing in-app messages to the customers, or delivering targeted web site messages to the customers.

17. The method of claim 14, further comprising:
causing targeted advertising to be provided to the displayed or exported customers.

18. The method of claim 17, wherein causing targeted advertising to be provided to the displayed or exported customers comprises sending email marketing to the customers, pushing mobile notifications to the customers, providing in-app messages to the customers, or delivering targeted web site messages to the customers.

19. A system for displaying customer behavior measurements to a user, the system comprising:
one or more processors configured perform instructions; and
a memory configured to store the instructions, the instructions when executed cause the computer to perform:
categorizing each of a plurality of customers into one of a plurality of lifecycle stages based on one or more interactions of each of the plurality of customers with a seller, wherein each of the plurality of lifecycle stages corresponds to a different stage of relationship between customers and the seller, wherein each interaction is represented by a data record in a data storage;
displaying a first value associated with each of the plurality of lifecycle stages, wherein the first value comprises a number of the plurality of customers categorized in its associated lifecycle stage or a percentage that the number of the plurality of customers categorized in its associated lifecycle stage represents across all lifecycle stages;
for each of the plurality of lifecycles stages, categorizing each of the corresponding customers into one of a plurality of buying cycle stages based a type of interaction with the seller for each of the corresponding customers, wherein each of the plurality of buying cycle stages corresponds to a different stage of buying behavior for the customers;
displaying a second value associated with each of the plurality of buying cycle stages, wherein the second value comprises a number of the corresponding customers categorized in its associated buying cycle stage or a percentage that the number of the plurality of customers categorized in its associated buying cycle stage represents across all buying cycle stages;
for each of the plurality of lifecycle stages or for each of the plurality of buying cycles stages, categorizing each of the corresponding customers into one of a plurality of dimension groups based on a type of a dimension characterizing the interaction with the seller for each of the corresponding customers; and
displaying a third value associated with each of the plurality of dimension groups, wherein the third value comprises a number of the corresponding customers categorized in its associated dimension group or a percentage that the number of the corresponding customers categorized in its associated dimension group represents across all dimension groups.
